(19) United States
(12) Patent Application Publication
(10) Pub. No.: US 2026/0275741 A1
(43) Pub. Date: Sep. 17, 2026

(54) PROTECTIVE DRAIN CAP FOR A DRAIN PORT OF A SWIMMING POOL FILTER UNIT AND METHOD THEREFOR

(71) Applicant: Paula Phelps, Connersville, IN (US)

(72) Inventor: Paula Phelps, Connersville, IN (US)

(21) Appl. No.: 19/077,952

(22) Filed: Mar. 12, 2025

(51) Int. Cl. E04H 4/12; B01D 35/28

(52) U.S. Cl. CPC E04H 4/1218; B01D 35/28; B01D 2201/4092

(57) ABSTRACT

A protective drain cap for a drain port of a swimming pool filter unit includes a body, a female threading, and at least one aperture. The body is cylindrical and includes a front wall and a perimeter wall extending perpendicularly from the front wall. The front wall and the perimeter wall enclose a receptacle in the body. The body includes pest-resistant material to prevent damage to the drain port of the swimming pool filter unit from chewing by a pest. The female threading is positioned on an inner surface of the receptacle and designed to matingly engage with a male threading of the drain port. The aperture is formed in the front wall. The aperture is connected to the receptacle for drainage of water from the drain port of the swimming pool filter unit through the front wall when the swimming pool filter unit is not in use.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to protective covers for drains and more particularly pertains to a new protective drain cap for a drain port of a swimming pool filter unit, such as a sand filter unit. When a swimming pool is not in use, such as during the winter, the swimming pool filter unit is turned off. However, water can continue to leak out of the drain port in the swimming pool filter unit over time. The leaking water attracts pests and wildlife, such as squirrels, mice, and rats, that wish to drink the water. The problem is that in drinking the water, such creatures tend to chew or gnaw on the drain port, which causes substantial damage that could at best damage the drain port itself and at worst compromise the entire swimming pool filter unit, thereby necessitating an expensive repair or replacement. The new protective drain cap deters or prevents pests from damaging the drain port and the swimming pool filter unit while still allowing for drainage of water.

### (2) Description of Related Art Including Information Disclosed Under 37 CFR 1.97 and 1.98

The prior art relates to drain caps. The prior art, as best understood, does not disclose a protective drain cap for a drain port of a swimming pool filter unit that includes a body, a female threading, and at least one aperture, wherein the body includes pest-resistant material to prevent damage to the drain port of the swimming pool filter unit from chewing by a pest.

### BRIEF SUMMARY OF THE INVENTION

An embodiment of the disclosure meets the needs presented above in a protective drain cap for a drain port of a swimming pool filter unit generally comprising a body, a female threading, and at least one aperture. The body is cylindrical and includes a front wall and a perimeter wall extending perpendicularly from the front wall. The front wall and the perimeter wall enclose a receptacle in the body. The body includes pest-resistant material to prevent damage to the drain port of the swimming pool filter unit from chewing by a pest. The female threading is positioned on an inner surface of the receptacle. The female threading is designed to matingly engage with a male threading of the drain port of the swimming pool filter unit. The aperture is formed in the front wall. The aperture is connected to the receptacle for drainage of water from the drain port of the swimming pool filter unit through the front wall when the swimming pool filter unit is not in use.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a protective drain cap according to an embodiment of the disclosure.

FIG. 2 is a rear perspective view of an embodiment of the disclosure.

FIG. 3 is a front view of an embodiment of the disclosure.

FIG. 4 is a side cross-sectional view of the embodiment of the disclosure in FIG. 3.

FIG. 5 is a perspective view of an embodiment of the disclosure in use.

FIG. 6 is a perspective view of an embodiment of the disclosure in use.

FIG. 7 is a perspective view of an embodiment of the disclosure in use.

### DETAILED DESCRIPTION OF THE INVENTION

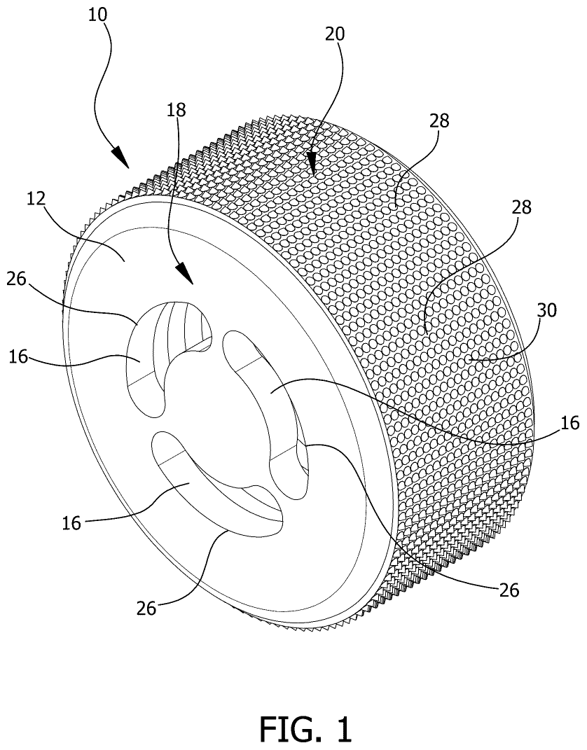

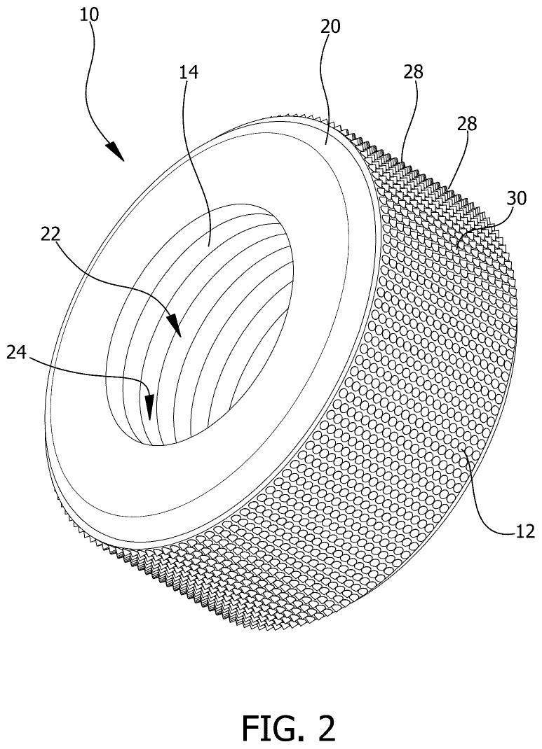

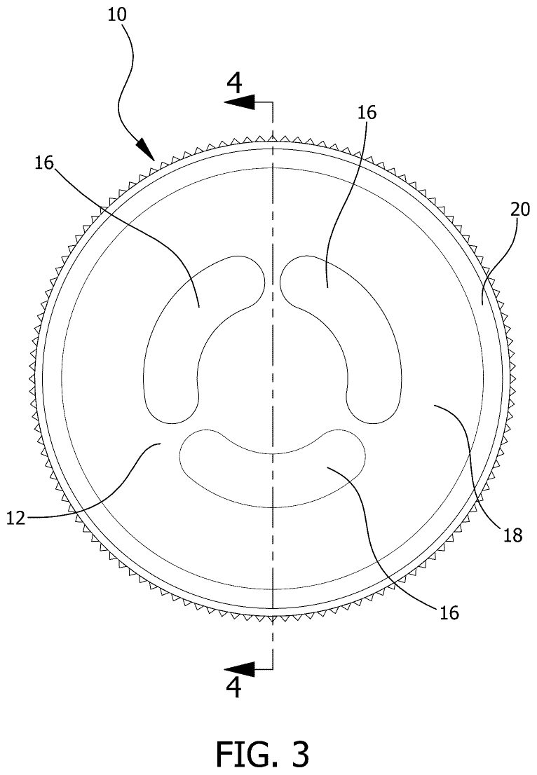

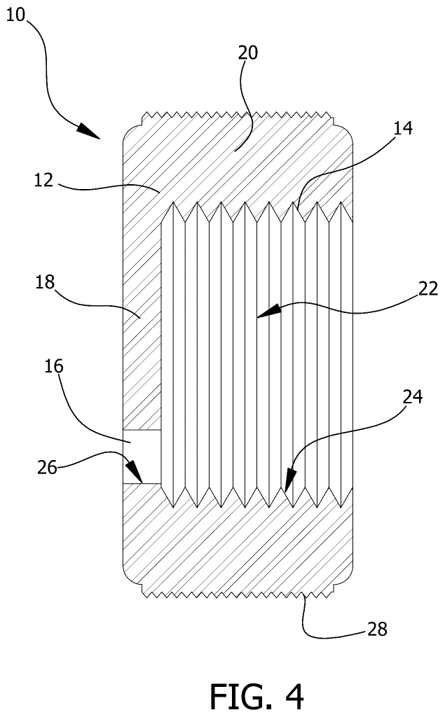

With reference now to the drawings, and in particular to FIGS. 1 through 7 thereof, a new protective drain cap embodying the principles and concepts of an embodiment of the disclosure and generally designated by the reference numeral 10 will be described.

As best illustrated in FIGS. 1 through 7, the protective drain cap 10 for a drain port 62 of a swimming pool filter unit 60 generally comprises a body 12, a female threading 14, and at least one aperture 16. The body 12 is cylindrical and includes a front wall 18 and a perimeter wall 20 extending perpendicularly from the front wall 18. The front wall 18 and the perimeter wall 20 enclose a receptacle 22 in the body 12. The body 12 includes pest-resistant material to prevent damage to the drain port 62 of the swimming pool filter unit 60 from chewing by a pest. The female threading 14 is positioned on an inner surface 24 of the receptacle 22. The female threading 14 is designed to matingly engage with a male threading 64 of the drain port 62 of the swimming pool filter unit 60. The aperture 16 is formed in the front wall 18. The aperture 16 is connected to the receptacle 22 for drainage of water from the drain port 62 of the swimming pool filter unit 60 through the front wall 18 when the swimming pool filter unit 60 is not in use.

In the exemplary embodiment, the body 12 consists of metal, such as aluminum. Other types of metal, such as stainless steel or iron, could be used. The metal could have a weather-resistant coating, such as clear coating or powder coating. In another possible embodiment, the body 12 could be made of a carbide, ceramic, or ceramic carbide. In yet another possible embodiment, the body 12 could be made of a high strength plastic, such as heavy duty polyvinyl chloride (PVC) plastic. Most any material or combination of materials is suitable as long as the material is resistant to chewing or gnawing by rodents and other small mammals.

In the exemplary embodiment, the body 12 is 1.0 to 4.0 inches in diameter and 1.0 to 3.0 inches in height. Other dimensions suitable for fitting onto the drain port 62 are within the scope of the disclosure.

The protective drain cap 10 could possibly have only one aperture 16, but the exemplary embodiment includes a plurality of the apertures 16. In the exemplary embodiment in FIG. 1, each of the apertures 16 is a curved slot having an outer edge 26 positioned to follow the inner surface 24 of the receptacle 22 to provide drainage regardless of a rotational position of the body 12 on the drain port 62 of the swimming pool filter unit 60. Since the water would flow along the bottom of the drain port 62 and/or the receptacle 22, placement of the outer edge 26 of each of the apertures 16 in alignment with the inner surface 24 of the receptacle 22 ensures drainage to prevent buildup of water, and thus possibly ice, inside the protective drain cap 10.

In the exemplary embodiment in FIG. 1, the protective drain cap 10 also includes a plurality of projections 28 positioned on an outer surface 30 of the perimeter wall 20 to provide a grip for manual turning of the body 12. The projections 28 could be integrally formed with the body 12 or could be part of an additional layer positioned on the perimeter wall 20. The projections 28 could be a series of rounded bumps to create a knurled surface, such as shown in the exemplary embodiment in FIG. 1, though virtually any shape that provides enhanced gripping, such as ridges or depressions, is within the scope of the disclosure.

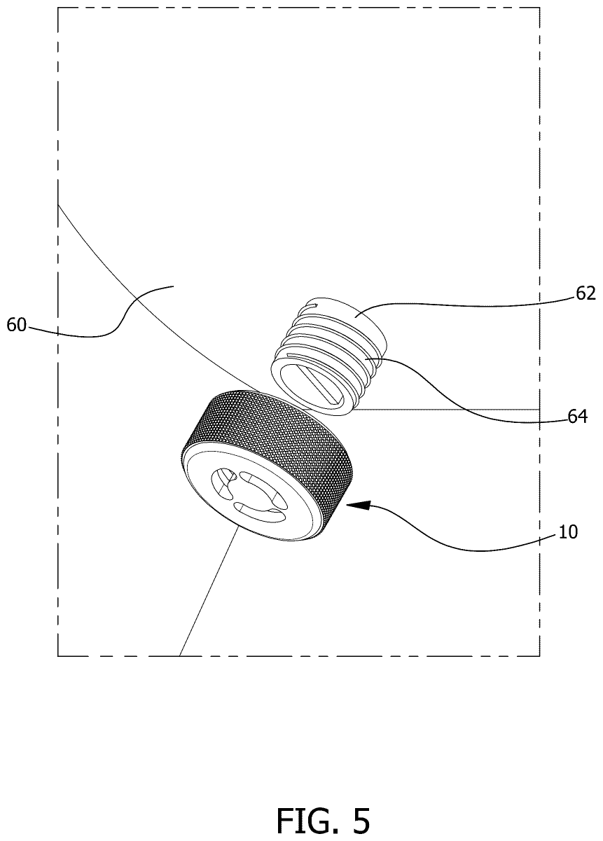

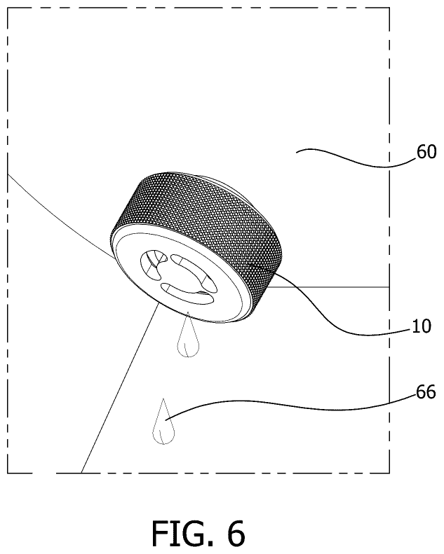

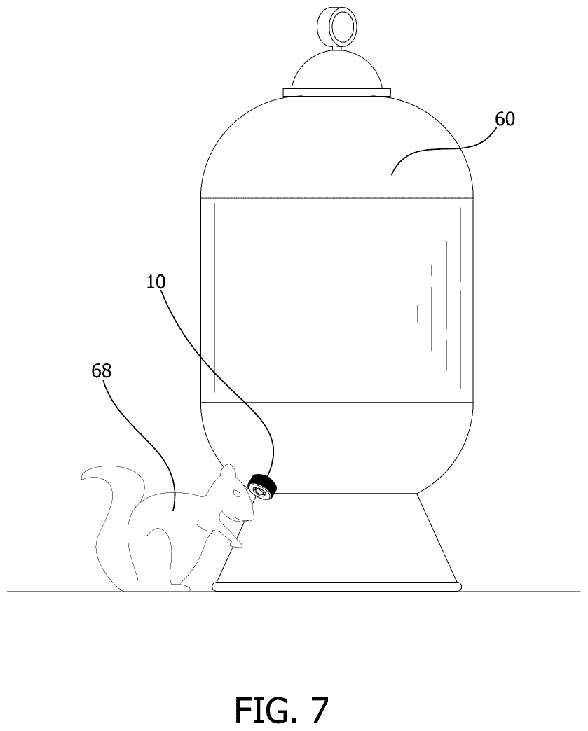

FIGS. 5 through 7 show an example of the protective drain cap 10 in use. After the user has turned off the swimming pool filter unit 60, such as a sand filter unit shown in FIG. 7, the user can remove the standard plastic cover (not shown). The user can then screw the protective drain cap 10 onto the drain port 62 of the swimming pool filter unit 60, as shown in FIG. 5. Water 66 can drain from the drain port 62 through the front wall 18, as shown in FIG. 6. Creatures, such as a squirrel 68 shown in FIG. 7, can drink the water 66 but will be prevented from damaging the swimming pool filter unit 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A protective drain cap for a drain port of a swimming pool filter unit comprising:
a body, said body being cylindrical and including a front wall and a perimeter wall extending perpendicularly from said front wall, said front wall and said perimeter wall enclosing a receptacle in said body, said body includes pest-resistant material to prevent damage to a drain port of a swimming pool filter unit from chewing by a pest;
a female threading, said female threading being positioned on an inner surface of said receptacle, said female threading being configured to matingly engage with a male threading of the drain port of the swimming pool filter unit; and
at least one aperture, said at least one aperture being formed in said front wall, said at least one aperture being connected to said receptacle for drainage of water from the drain port of the swimming pool filter unit through said front wall when the swimming pool filter unit is not in use.

2. The protective drain cap of claim 1, wherein said body consists of metal.

3. The protective drain cap of claim 2, wherein said metal is aluminum.

4. The protective drain cap of claim 1, wherein said body is 1.0 to 4.0 inches in diameter and 1.0 to 3.0 inches in height.

5. The protective drain cap of claim 1, wherein said at least one aperture includes a plurality of apertures.

6. The protective drain cap of claim 5, wherein each of said apertures is a curved slot having an outer edge positioned to follow said inner surface of said receptacle to provide drainage regardless of a rotational position of said body on the drain port of the swimming pool filter unit.

7. The protective drain cap of claim 1, further comprising a plurality of projections positioned on an outer surface of said perimeter wall to provide a grip for manual turning of said body.

8. The protective drain cap of claim 3, wherein said body is 1.0 to 4.0 inches in diameter and 1.0 to 3.0 inches in height.

9. The protective drain cap of claim 8, wherein said at least one aperture includes a plurality of apertures.

10. The protective drain cap of claim 9, wherein each of said apertures is a curved slot having an outer edge positioned to follow said inner surface of said receptacle to provide drainage regardless of a rotational position of said body on the drain port of the swimming pool filter unit.

11. The protective drain cap of claim 10, further comprising a plurality of projections positioned on an outer surface of said perimeter wall to provide a grip for manual turning of said body.

12. A method of protecting a drain port of a swimming pool filter unit, said method comprising the steps of:
providing a protective drain cap comprising:
a body, said body being cylindrical and including a front wall and a perimeter wall extending perpendicularly from said front wall, said front wall and said perimeter wall enclosing a receptacle in said body;
a female threading, said female threading being positioned on an inner surface of said receptacle, said female threading being configured to matingly engage with a male threading of a drain port of a swimming pool filter unit; and
at least one aperture, said at least one aperture being formed in said front wall, said at least one aperture being connected to said receptacle for drainage of water from the drain port of the swimming pool filter unit through said front wall when the swimming pool filter unit is not in use;
turning off the swimming pool filter unit; and
screwing said protective drain cap onto the drain port of the swimming pool filter unit to drain water from the drain port of the swimming pool filter unit through said front wall when the swimming pool filter unit is not in use.
